(19) United States
(12) Patent Application Publication
(10) Pub. No.: US 2003/0051949 A1
(43) Pub. Date: Mar. 20, 2003

(54) Lateral moving device for an elevator or the like

(76) Inventor: Chin Ming Chen, Taichung (TW)

Correspondence Address: Chin Ming Chen, P.O. Box 63-99, Taichung, 406, TW

(21) Appl. No.: 09/960,149

(22) Filed: Sep. 20, 2001

(51) Int. Cl. B66B 1/06

(52) U.S. Cl. 187/289

(57) ABSTRACT

A lateral moving device includes a frame slidably engaged on a rail and movable along the rail, a bar slidably engaged on the frame and movable along the frame, and/or a beam slidably engaged on the bar and movable along the bar. A number of gears and racks and gears or pinions may be disposed in the rail and the frame and the bar and the beam and coupled with each other for allowing the beam to be moved relative to the bar and the bar to be moved relative to the frame when the frame is moved relative to the rail, and for further moving goods or objects sidewise.

### BACKGROUND OF THE INVENTION

1. Field of the Invention

The present invention relates to a lateral moving device, and more particularly to a lateral moving device for an elevator or the like.

2. Description of the Prior Art

Typical fork lift devices or fork lift trucks or lifters are primarily used for elevating goods or objects to a higher position for storing purposes. However, the lifters may not be used for suitably moving the goods or the objects laterally to the side portions.

The present invention has arisen to mitigate and/or obviate the afore-described disadvantages of the conventional lateral moving devices.

### SUMMARY OF THE INVENTION

The primary objective of the present invention is to provide a lateral moving device for an elevator or the like and for suitably moving the goods or the objects laterally to the side portions of the building or of the elevator.

In accordance with one aspect of the invention, there is provided a lateral moving device comprising a rail, a frame slidably engaged on the rail and movable along the rail, a bar slidably engaged on the frame and movable along the frame, and means for moving the frame relative to the rail and moving the bar relative to the frame.

The rail includes a pair of tracks for slidably supporting the frame. The tracks each includes a channel formed therein, the frame includes at least two rollers and/or at least two gaskets slidably engaged in the channels of the tracks for facilitating a movement of the frame relative to the rail.

The moving means includes a first rack secured in the frame, a first gear rotatably secured in the rail and engaged with the first rack, and means for rotating the first gear to move the first rack and the frame relative to the rail.

The rotating means includes a motor, and means for coupling the motor to the first gear and to rotate the first gear. The coupling means includes a spindle rotatably secured to the rail and secured to the first gear, and engaged with the motor for being rotating by the motor.

The rail includes a base having an aperture formed therein for rotatably receiving the first gear.

The moving means includes a second rack secured on the rail, a third rack secured on the bar, at least one second gear rotatably secured to the first rack and engaged with the second rack and the third rack, for moving the third rack and the bar relative to the frame when the frame is moved relative to the rail. The frame includes a partition having a passageway formed therein for rotatably receiving the second gear.

A beam is further provided and slidably engaged on the bar. The moving means includes a fourth rack secured on the frame, a fifth rack secured on the beam, and means for connecting between the fourth rack and the fifth rack.

The connecting means includes at least one third gear rotatably secured to the third rack of the bar and engaged with the fifth rack of the beam, and a pinion rotatably secured to the third rack of the bar and engaged with the fourth rack of the frame. The bar includes an opening formed therein for rotatably receiving the third gear.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a plan schematic view of an elevator or the like having a lateral moving device in accordance with the present invention;

FIG. 2 is a partial perspective view of the lateral moving device and the elevator;

FIG. 3 is a partial perspective view of the lateral moving device for the elevator;

FIG. 4 is a cross sectional view taken along lines 4-4 of FIG. 3;

FIG. 5 is a partial cross sectional view similar to FIG. 4, in which some of the parts or elements have been removed for showing the primary structure of the lateral moving device;

FIGS. 6 and 7 are partial perspective views of the lateral moving device for the elevator;

FIG. 8 is a partial plan schematic view illustrating the engagement of the gears and pinions and tracks of the lateral moving device; and

FIG. 9 is a plan schematic view illustrating the operation of the lateral moving device.

### DETAILED DESCRIPTION OF THE PREFERRED EMBODIMENT

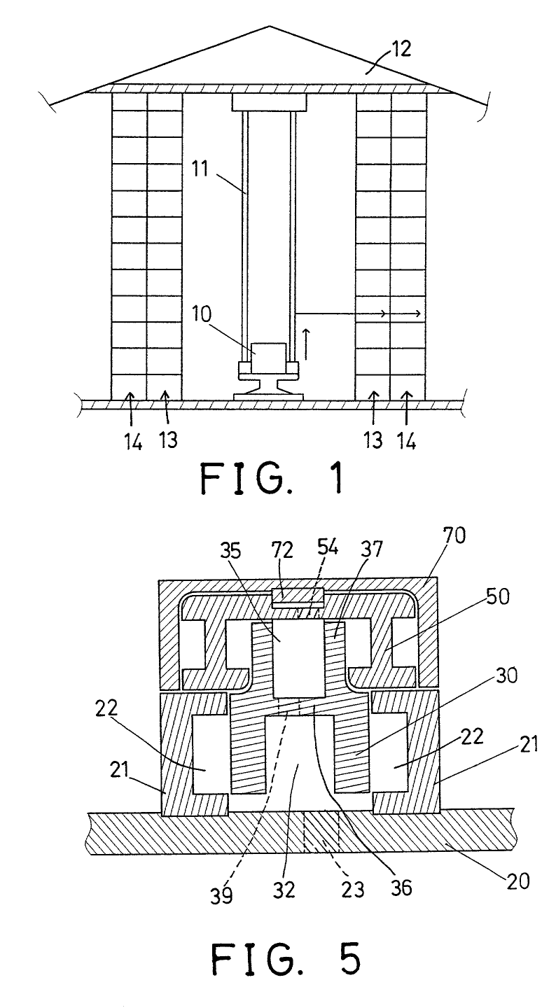

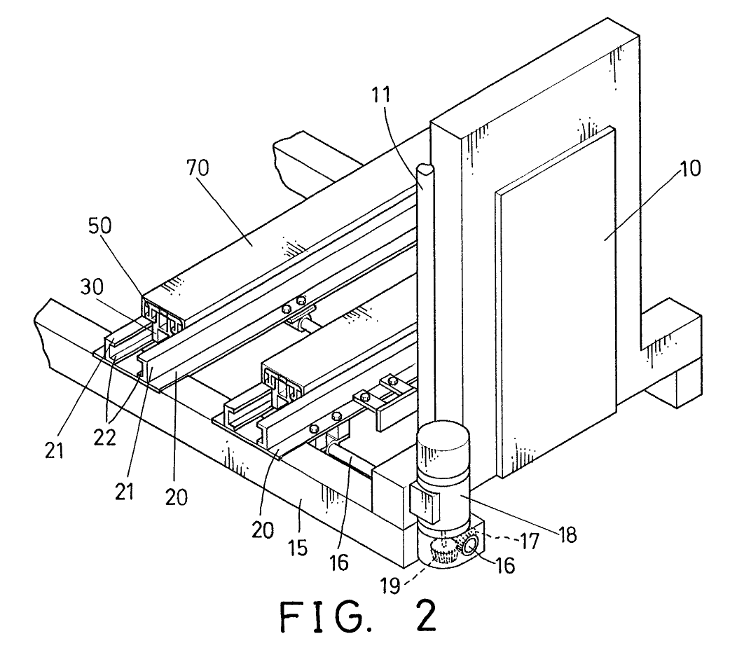

Referring to the drawings, and initially to FIGS. 1 and 2, illustrated is an elevator 10 slidably supported or provided in a building or a warehouse 12, and slidably secured to one or more guide posts 11, for allowing the elevator 10 to be moved up and down along the guide posts 11. A lateral moving device in accordance with the present invention is provided and disposed on the elevator 10 and movable laterally relative to the elevator 10, for moving the goods or the objects to the side portions 13 and/or the further side portions 14 of the building or the warehouse 12, and for such as the storing purposes.

As shown in FIG. 2, the elevator 10 includes a base 15, and a spindle 16 rotatably secured in the base 15 and having a pinion or a bevel gear 17 disposed and secured thereon and rotated in concert therewith. A motor 18 is secured to the base 15 and includes a pinion or a bevel gear 19 attached thereto and engaged with the bevel gear 17, for driving or rotating the spindle 16. The motor 18 may also be used for moving the elevator 10 up and down along the guide posts 11. Alternatively, the elevator 10 may also be moved up and down along the guide posts 11 with the other driving mechanisms or facilities.

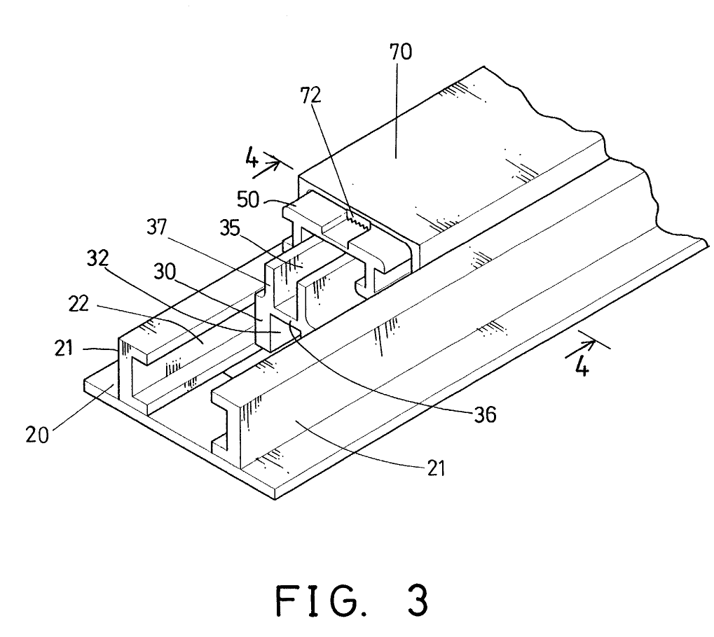

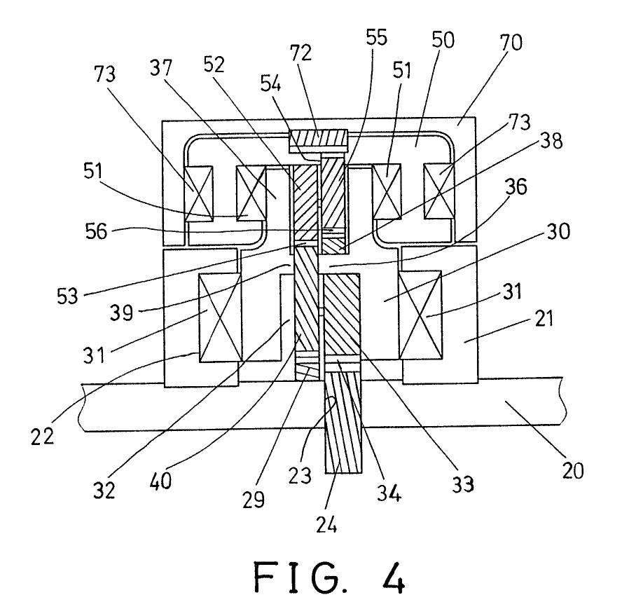

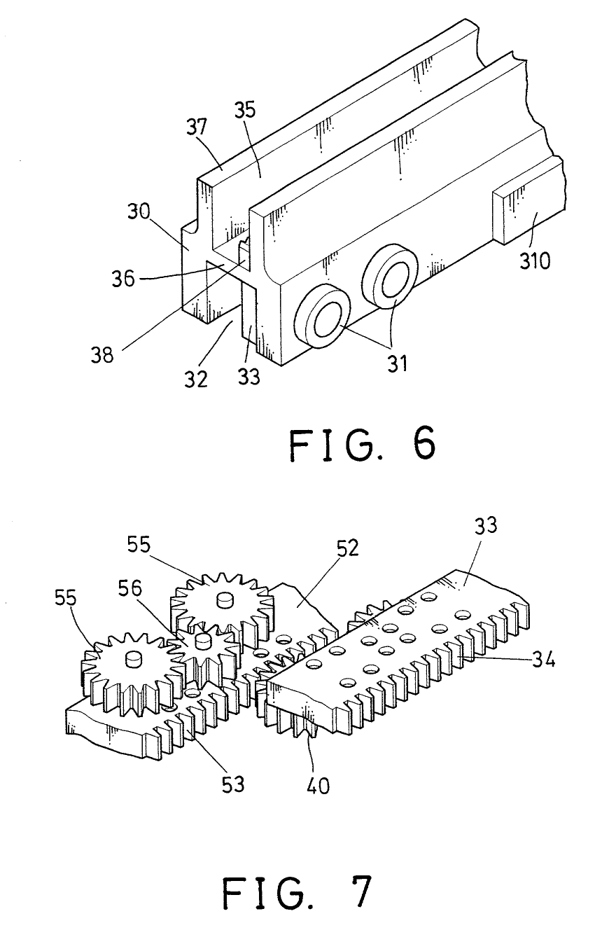

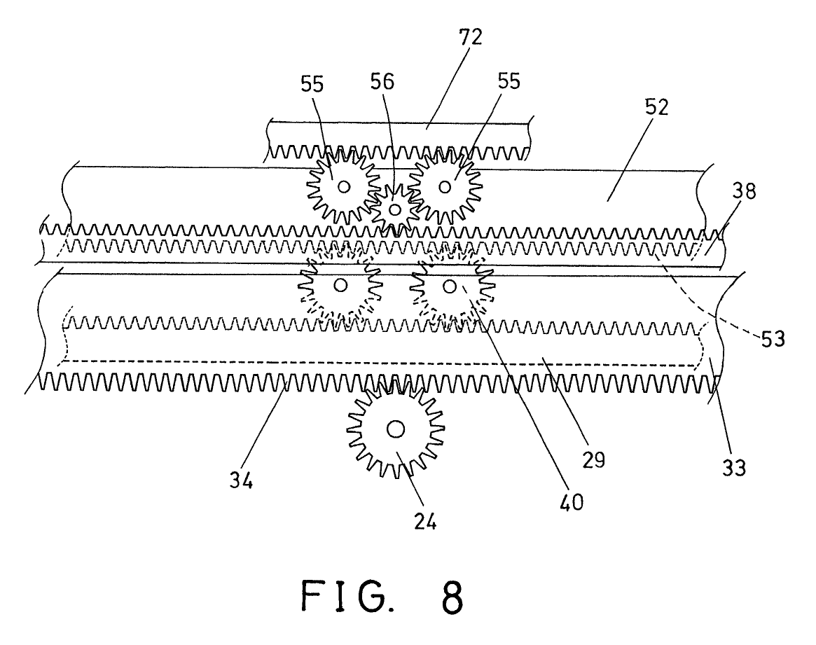

Referring next to FIGS. 3-8, and again to FIG. 2, the lateral moving device in accordance with the present invention comprises one or more, such as two rails 20 secured or supported on the base 15 of the elevator 10. The rails 20 each includes a pair of opposite tracks 21 disposed thereon and parallel to each other and each having a channel 22 formed therein. The rails 20 each includes an aperture 23 formed therein and formed between the tracks 21 (FIGS. 4, 5), and each includes a gear 24 rotatably received in the aperture 23 and secured to the spindle 16, such that the gear 24 may be driven by the motor 18 via the spindle 16. The rails 20 each includes a rack 29 (FIGS. 4, 8) secured therein and disposed between the tracks 21.

A frame 30 has a lower portion slidably engaged in each of the rails 20. For example, the frames 30 each includes one or more wheels or rollers 31 and/or one or more gaskets 310 attached to the side portions and rotatably or slidably received in the respective channels 22 of the tracks 21, for allowing the frames 30 to be smoothly moved along the respective rails 20. The frames 30 each includes a chamber 32 formed in the lower portion thereof, a rack 33 secured in the chamber 32 thereof, a space 35 formed in the upper portion thereof and formed or defined between a pair of walls 37, a partition 36 formed or provided between the lower chamber 32 32 and the upper space 35 thereof, and another rack 38 secured on the partition 36 and received in the upper space 35 thereof. The partition 36 includes a passageway 39 formed therein (FIGS. 4, 5). The rack 33 has a number of teeth 34 engaged with the gear 24 such that the rack 33 and thus the frame 30 may be moved along the respective rail 20 by the motor 18 via the spindle 16 and the gear 24.

One or more, such as two gears 40 are rotatably secured to the rack 33 and engaged with the rack 29 (FIG. 4), such that the lower portion of the gears 40 may be stably supported in place by the rack 29. The gears 40 are engaged through the passageway 39 of the partition 36 of the frame 30 and extended upward and inward of the upper space 35 of the frame 30. A bar 50 is slidably engaged on each of the frames 30 with such as the wheels or rollers or bearings 51, and includes a rack 52 secured thereto and received in the upper space 35 of the frame 30 and having a number of teeth 53 engaged with the gears 40 of the rack 33. The bars 50 each includes an opening 54 formed in the upper and middle portion thereof and communicating with the upper space 35 of the frame 30 respectively.

In operation, as best shown in FIG. 8, when the frame 30 and thus the rack 33 is moved, such as rightward, relative to the rail 20 and the rack 29 that is secured in the rail 20, the gears 40 may also be moved, rightward, by the frame 30. The lower portion of the gears 40 are engaged with the rack 29 that is secured on the rail 20, such that the lower portion of the gears 40 will not be moved rightward by the rack 33. However, the upper portion of the gears 40 that are engaged with the rack 52 will be moved with a moving stroke twice as that of the center of the gears 40; i.e., the rack 52 and thus the bar 50 may be moved rightward relative to the frame 30, and may be moved further than the frame 30. For example, when the frame 30 is moved relative to the rail 20 for a distance, the bar 50 may move twice of the distance relative to the frame 30 than the distance of the frame 30 relative to the rail 20.

A beam 70 is slidably engaged onto each of the bars 50, with such as one or more wheels or rollers or bearings 73, and includes a rack 72 secured therein. One or more, such as two gears 55 are rotatably secured to the rack 52 and engaged through the opening 54 of the bar 50 and extended upward through the bar 50 for engaging with the rack 52 of the bar 50. A pinion 56 is engaged with the gears 55 and has a lower portion engaged with the rack 38 of the frame 30 (FIG. 4), such that the lower portion of the gears 55 may be stably coupled to the frame 30 with the pinion 56.

In operation, as best shown in FIG. 8, when the bar 50 and thus the rack 52 is moved, such as rightward, relative to the frame 30 and the rack 38 that is secured in the frame 30 as described before, the gears 55 may also be moved, rightward, by the rack 52 and the bar 50. The lower portions of the gears 55 are engaged with the rack 38 via the pinion 56, such that the lower portion of the gears 55 may be relatively and stably retained to the rack 38 and the frame 30. At this moment, the upper portion of the gears 55 are engaged with the rack 72 of the beam 70 and will move the rack 72 and thus the beam 70 rightward relative to the bar 50.

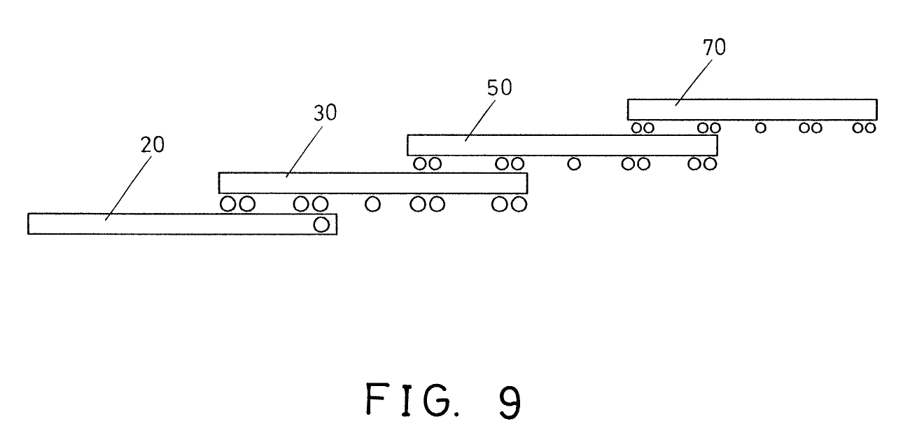

Referring next to FIG. 9, accordingly, when the frame 30 is moved rightward relative to the rail 20 by the motor 18 with the gear 24 and the spindle 16 (FIGS. 1, 4), the bar 50 may also be moved further rightward relative to the frame 30, and the beam 70 may also be moved further rightward relative to the bar 50, such that the goods or the objects that are supported or disposed on the beams 70 may be moved further laterally toward the further side portions 14 of the building or the warehouse 12 (FIG. 1), and for such as the storing purposes. A table or a platform (not shown) or the like may further be provided and disposed on the beam(s) 70 for stably supporting the goods or the objects on the beam(s) 70.

Accordingly, the lateral moving device in accordance with the present invention may be provided for an elevator or the like and for suitably moving the goods or the objects laterally to the side portions of the building or of the elevator.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A lateral moving device comprising:
a rail,
a frame slidably engaged on said rail and movable along said rail,
a bar slidably engaged on said frame and movable along said frame, and
means for moving said frame relative to said rail and moving said bar relative to said frame.

2. The lateral moving device according to claim 1, wherein said rail includes a pair of tracks for slidably supporting said frame.

3. The lateral moving device according to claim 2, wherein said tracks each includes a channel formed therein, said frame includes at least two rollers slidably engaged in said channels of said tracks for facilitating a movement of said frame relative to said rail.

4. The lateral moving device according to claim 2, wherein said tracks each includes a channel formed therein, said frame includes at least two gaskets slidably engaged in said channels of said tracks for facilitating a movement of said frame relative to said rail.

5. The lateral moving device according to claim 1, wherein said moving means includes a first rack secured in said frame, a first gear rotatably secured in said rail and engaged with said first rack, and means for rotating said first gear to move said first rack and said frame relative to said rail.

6. The lateral moving device according to claim 5, wherein said rotating means includes a motor, and means for coupling said motor to said first gear and to rotate said first gear.

7. The lateral moving device according to claim 6, wherein said coupling means includes a spindle rotatably secured to said rail and secured to said first gear, and engaged with said motor for being rotating by said motor.

8. The lateral moving device according to claim 5, wherein said rail includes a base having an aperture formed therein for rotatably receiving said first gear.

9. The lateral moving device according to claim 5, wherein said moving means includes a second rack secured on said rail, a third rack secured on said bar, at least one second gear rotatably secured to said first rack and engaged with said second rack and said third rack, for moving said third rack and said bar relative to said frame when said frame is moved relative to said rail.

10. The lateral moving device according to claim 9, wherein said frame includes a partition having a passageway formed therein for rotatably receiving said at least one second gear.

11. The lateral moving device according to claim 9 further comprising a beam slidably engaged on said bar.

12. The lateral moving device according to claim 11, wherein said moving means includes a fourth rack secured on said frame, a fifth rack secured on said beam, and means for connecting between said fourth rack and said fifth rack.

13. The lateral moving device according to claim 12, wherein said connecting means includes at least one third gear rotatably secured to said third rack of said bar and engaged with said fifth rack of said beam, and a pinion rotatably secured to said third rack of said bar and engaged with said fourth rack of said frame.

14. The lateral moving device according to claim 13, wherein said bar includes an opening formed therein for rotatably receiving said at least one third gear.

15. A lateral moving device comprising:
a rail,
a frame slidably engaged on said rail and movable along said rail,
a bar slidably engaged on said frame and movable along said frame,
a beam slidably engaged on said bar and movable along said bar, and
means for moving said frame relative to said rail and moving said bar relative to said frame, and moving said beam relative to said bar.

16. The lateral moving device according to claim 15, wherein said moving means includes a first rack secured in said frame, a first gear rotatably secured in said rail and engaged with said first rack, a second rack secured on said rail, a third rack secured on said bar, at least one second gear rotatably secured to said first rack and engaged with said second rack and said third rack for moving said third rack and said bar relative to said frame when said frame is moved relative to said rail, a fourth rack secured on said frame, a fifth rack secured on said beam, and means for connecting between said fourth rack and said fifth rack.

17. The lateral moving device according to claim 16, wherein said connecting means includes at least one third gear rotatably secured to said third rack of said bar and engaged with said fifth rack of said beam, and a pinion rotatably secured to said third rack of said bar and engaged with said fourth rack of said frame.

18. The lateral moving device according to claim 16 further comprising means for rotating said first gear to move said first rack and said frame relative to said rail.

19. The lateral moving device according to claim 18, wherein said rotating means includes a motor, and means for coupling said motor to said first gear and to rotate said first gear.
